(19) United States
(12) Patent Application Publication
(10) Pub. No.: US 2004/0133592 A1
(43) Pub. Date: Jul. 8, 2004

(54) Journal for capturing and data pump for transmitting detailed machine control information to client applications

(76) Inventors: Surya Sagi, Southbury, CT (US); Deborah R. McManus, Bethel, CT (US); William G. Hart JR., Sandy Hook, CT (US); Bruce Barrows, Danbury, CT (US)

Correspondence Address: Pitney Bowes Inc., Intellectual Property and Technology Law Dept., 35 Waterview Drive, P.O. Box 3000, Shelton, CT, 06484, US

(21) Appl. No.: 10/694,503

(22) Filed: Oct. 24, 2003

Related U.S. Application Data
(60) Provisional application No. 60/421,876, filed on Oct. 28, 2002.

(51) Int. Cl. G06F 17/00

(52) U.S. Cl. 707/102

(57) ABSTRACT

A system for gathering and transmitting detailed inserter machine data to one or more clients. The inserter controller gathers substantially all significant machine data from machine sensors and control routines data relating to the operation of the machine and the processing of mail pieces. The gathered data is stored in a compressed format in journal format. A data pump processes the compressed journal data, extracting those parts that are of interest, and transmitting them to client applications in a format that is easily interpreted. The data pump processing includes selecting a subset of data from the journal that is of interest to the particular client.

This application claims priority under 35 U.S.C. § 119(e) from U.S. Provisional Application 60/421,876 dated Oct. 28, 2002, titled Journal for Capturing and Data Pump for Transmitting Detailed Machine Control Information To Client Applications, which is hereby incorporated by reference in its entirety.

### TECHNICAL FIELD

The present invention relates to a system for gathering data and monitoring document production equipment and systems. Such equipment and systems may include high volume printers, inserter machines, mail sorting machines, and the like.

### BACKGROUND

Systems for mass producing mail pieces are well known in the art. Such systems are typically used by organizations such as banks, insurance companies and utility companies for producing a large volume of specific mailings like billing statements, or promotional offers.

In many respects the typical inserter system resembles a manufacturing assembly line. Sheets and other raw materials (other sheets, enclosures, and envelopes) enter the inserter system as inputs. Modules or workstations in the inserter system work cooperatively to process the sheets into a finished mail piece. The exact configuration of each inserter system depends upon the needs of each particular customer or installation.

Typically, inserter systems prepare mail pieces by gathering collations of documents on a conveyor. The collations are then transported on the conveyor to an insertion station where they are automatically stuffed into envelopes. After being stuffed with the collations, the envelopes are removed from the insertion station for further processing. Such further processing may include automated closing and sealing the envelope flap, weighing the envelope, applying postage to the envelope, and finally sorting and stacking the envelopes.

Each collation of documents processed by the inserter system typically includes a control document having coded control marks printed thereon. Scanners are located throughout the inserter system to sense documents and to allow control for processing of a particular mail piece. The coded marks may be bar codes, UPC code, or the like.

The inserter system control system is coupled to the inserter system's modular components. The control system stores data files identifying how individual mail pieces should be processed. These data files are typically linked to individual mail pieces by the coded marks included on the control documents. As a collation passes through the inserter system, the coded marks on the control document are scanned and the control system directs the modular components to assemble the mail piece as appropriate. Mail pieces such as billing statements will often include a reply document and/or a return envelope that is pre-addressed for delivery back to the originator of the mail piece. Such reply documents and return envelopes may be used to send back payments, or acceptances of offers, or the like.

Due to their computerized controls, inserter machines have the capability to capture information that is useful for later analysis. This might include machine performance data, operator productivity data, information about the quality and types of outputs produced by the machine, indications of potential problems, etc. In the case of automated mail inserting equipment, there have been many cases where such information from the inserter has been desired. Purposes for information gathering include measuring downtime, counting damaged pieces, and tracking postage.

As a need is identified to capture new information, custom modifications have been made to the machine control software to output data in a form that can be processed by the application that needs it. However, frequent customizations of this kind can lead to “clutter” in the machine control software and a proliferation of slightly customized, incompatible versions. Also, every time the basic machine control software is modified to add a new data collection scheme, there is a risk of introducing bugs, and in any case extensive testing is required after changes are made to verify that its basic functionality has been unaffected. This consumes significant engineering and testing resources, and temporarily distracts the machine from its essential function of producing output.

### SUMMARY OF THE INVENTION

The present invention addresses the shortcomings of the prior art by providing a system for gathering and transmitting detailed inserter machine data to one or more clients. The inserter controller gathers data relating to the operation of the machine and the processing of mail pieces. A feature of the present invention is that the gathered data is predetermined to comprise substantially all significant machine data from machine sensors and control routines. That is, even if the gathered data may not be useful to most inserter users, the data is still gathered in order to satisfy the minority of situations where that data may be desired. Accordingly, it is preferred that all data that is conceivably of interest be included in the predetermined gathered data.

The gathered data is stored in a compressed format in a journal device. The journaling mechanism includes algorithms and software by which machine control software can output data at a high level of detail about all of its essential functions to a file in a highly compressed format. Despite the level of detail, the data is sufficiently compressed that real-time performance of a machine as complicated as a high-speed inserter is not affected, even when the file is written over a network.

A further component of the invention is a data pump mechanism. The data pump can process the compressed journal data, extract those parts that are of interest, and transmit them to client applications in a format that is easily interpreted. The data pump processing includes selecting a subset of data from the journal that is of interest to the particular client.

Further details of the present invention are provided in the accompanying detailed description, figures and claims.

### SUMMARY OF THE FIGURES

FIG. 1 is a high level depiction of components of the invention.

FIG. 2 depicts exemplary detailed components for a system using the present invention.

FIG. 3 is an exemplary format for storing data in a journal.

FIG. 4 is a further exemplary format for storing data in a journal.

### DETAILED DESCRIPTION

The present invention may be used advantageously for gathering data and transmitting it to a document production management and control system such as the one described in co-pending patent application Ser. No. 10/280,339, titled, DOCUMENT LIFECYCLE TRACKING SYSTEM AND METHOD FOR USE WITH A DOCUMENT PRODUCTION PROCESS dated Oct. 25, 2002. This copending application is hereby expressly incorporated by reference. Gathered journal data may be useful both at the inserter machine 3 or at a remote client 4.

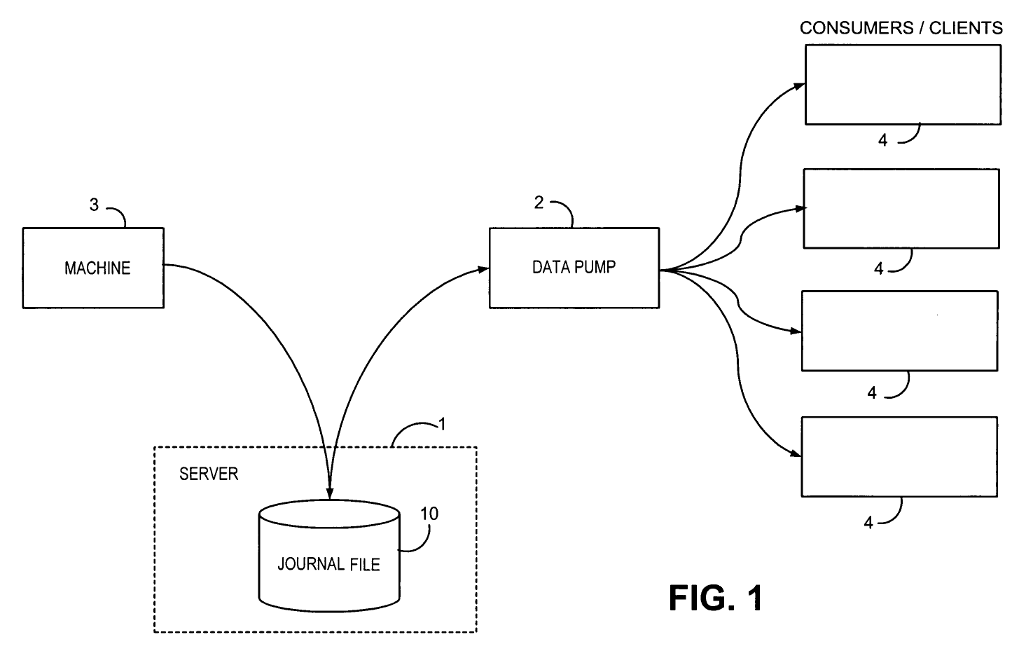

As seen in FIG. 1, a machine 3 is the source of the data that is generated. In the preferred embodiment machine 3 is an inserter system for mass producing pieces of mail. The inserter system includes a control system that gathers information both about the status of the machine and about the status of mail pieces that are being formed within the machine.

The gathered data is predetermined to comprise substantially all significant machine data from machine 3 sensors and control routines. Preferably, data is gathered from all available sources, so that any future needs can be met. This all-inclusive approach to gathering data minimizes the need for future modifications to the machine 3 control system if a particular machine user decides that a greater portion of the machine information is of interest. Top level data is gathered as well as low level granular data. Gathered data may include collation logs, production reporting, machine error analysis, metering cost analysis, manifesting, and any other information relevant to mail production.

The data gathered from machine 3 is stored on a server 1 that includes a journal file 10. The journal 10 serves as a centralized data collector that collects all data in a uniform manner, and that does not interfere with operation of the machine 3. The journal 10 data is preferably compressed, and formatted in a manner that will be discussed further below.

A data pump 2 processes the journal data for transmittal to clients 4. Preferably, journal data is provided by data pump 2 in real-time to clients 4. Changes are transmitted as they happen, and clients 4 may receive data for all mail runs. Depending on the data needed by the particular client 4, data pump 2 extracts and transmits the desired data for the particular client 4. The data pump preferably transforms the compressed data format into a format that is easily understood by the clients 4. For example, data pump 2 can reformat the compressed journal into an XML format that is easily interpreted by one or more of the clients 4.

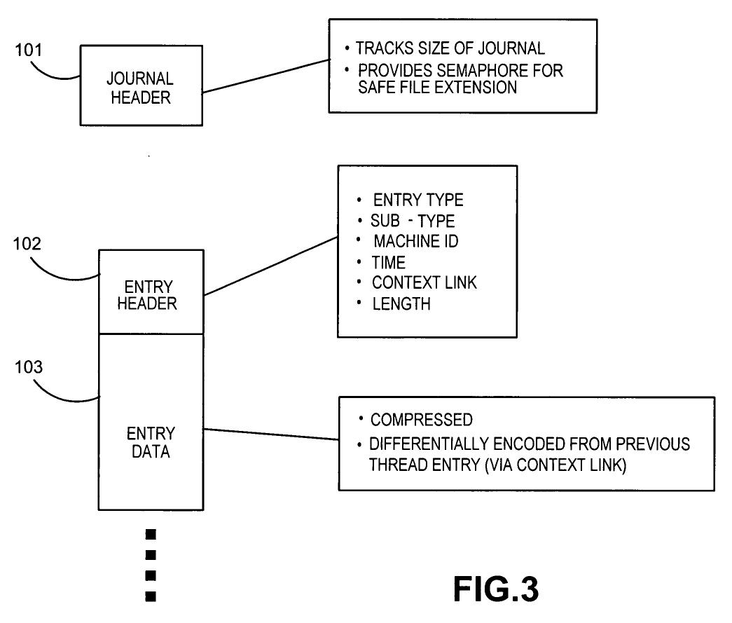

As seen in FIG. 3, machine 3 includes a mail processing application 30. The mail processing application 30 is a source of the machine data, and may typically comprise a controller program for the machine 3, or other application that receives data from machine sensors.

Information from a particular mail run is stored in journal 10. A mail run may be processed on multiple machines. Accordingly, a single journal file may include information for multiple machines. In the preferred embodiment, multiple journal files 10 for a plurality of different mail runs are stored in a mailrun warehouse 7. Data pump 2 selectively processes the multiple journal files in the mail run warehouse to provide the data to clients 4.

While a mail run journal is the preferred embodiment, the invention may also be implemented by storing a machine journal. A machine journal includes information for a particular machine. This is different than a mail run journal in that it will not include the interweaving of different threads for different machines as in a mail run journal.

The data pump 2 takes responsibility for making sure that the correct data is transmitted to the clients 4. This arrangement relieves the responsibility of retrieving data from the clients 4. Since clients 4 may be comprised of a variety of different types of applications, without the data pump 2 is would be difficult to ensure that the clients 4 were reliably receiving information. Data pump 2 includes client drivers 8 and data link 9 to facilitate providing the individualized data needs to each of the clients 4. Each client driver 8 ensures that the data is properly transmitted from the data pump 2. Some clients 4 may receive information in a format suitable for a database, while others may receive text information. Data pump 2 ensures that the information is transmitted in the format most easily understood by the client 4. Data pump 2 can provide journal data for all mail runs, and clients 4 can receive data for status changes as they happen.

In the preferred embodiment, data pump 2 tracks what information has been provided to each of the clients 4. If a client 4 becomes disconnected, or becomes inoperative, the data pump 2 will create a log identifying what data has been sent. When the client 4 is reconnected, data pump 2 recommences transmittal of data from the point at which the client stopped receiving data. In this manner, data pump 2 maintains on ongoing playback context for each client for each mail run journal. Clients 4 may be provided data incrementally, and clients 4 may provide incremental acknowledgements that data is received. Data pump 4 plays back data to the client 4 based on the last acknowledgement received from the client 4.

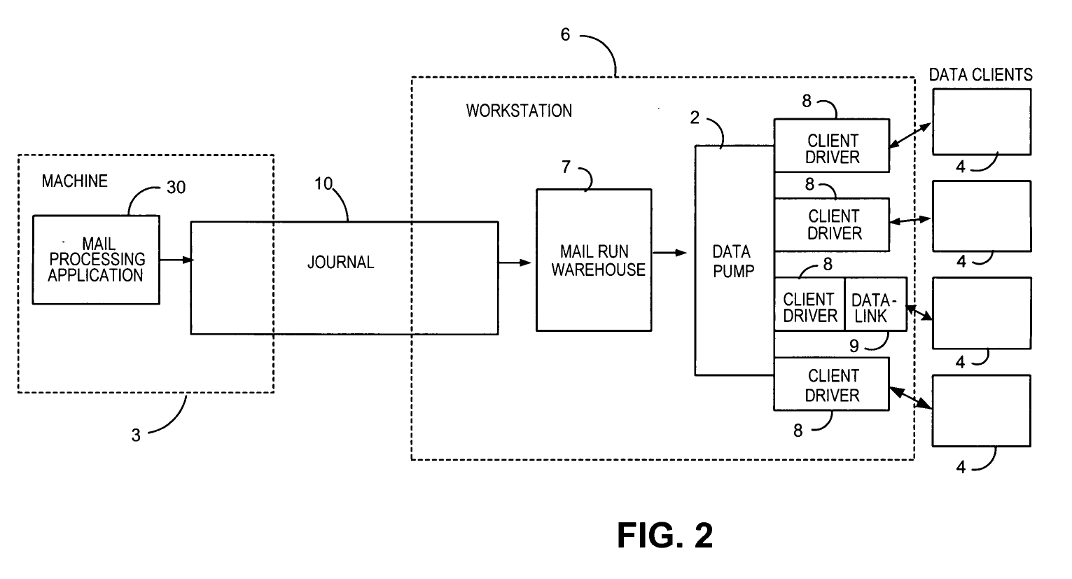

Using the arrangement depicted in FIGS. 1 and 2, the journal portion of the present invention can capture very detailed piece and production data. Such data includes state and historical information on all aspects of machine operation. Using journal 10 the machine 3 does not have to buffer data if a client 4 is down. This arrangement avoids having to add reliable non-volatile storage to each machine 3.

The data pump portion of the invention reliably moves data to clients 4. By using uniformly processed and formatted data, reliability is enhanced and the possibility of discrepancies between different reporting systems is reduced. Further the data pump 2 eliminates a need for multiple interfaces in machines 3. The journal 10 and data pump 2 combination also avoids having to upgrade and requalify machines 3 be eliminating the need to add a multiplicity of machine interfaces. The data pump 2 ensures that there is no data loss if client 4 is down and the clients 4 can catch up after being off-line. By further making operation of the machine 3 and data pump 2 independent of the clients 4, potential sources of mail production downtime are minimized.

FIG. 3 depicts an exemplary journal file 10 data format. A journal header 101 includes information on the size of the journal and provides an indication of the file extension to be used. An entry header 102 includes information describing the actual data entry 103. Entry header 102 may include the type of entry, a sub-category for the type of entry, a machine ID, the time of the entry, the context of the entry, and the length. The data entry 103 is compressed in the journal 10.

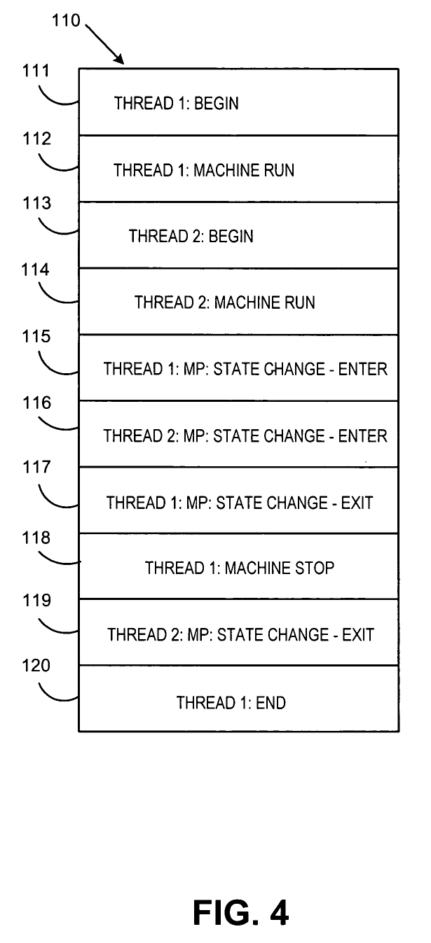

Each entry 103 can be differentiated from other entries by virtue of the context information. Such a context may be referred to as a “thread” that connects a series of entries to a particular type of information. For example, a thread may be formed for each machine 3 that is working on processing a particular mail run. FIG. 4 depicts an exemplary portion 110 of a journal file having entries 111-120. Each of these entries includes both an indication of the thread as well as a description of a status change that is occurring within the thread.

Referring back to FIG. 3, entries 103 preferably include several different kinds of entries. A first kind of entry is an event entry. Event entries describe actions of a machine 3 while processing mail pieces. Event entries mark distinct machine events and processing intervals.

Such event entries may include a machine state change, a mail piece state change, a meter trip, an alarm, a machine cycle, an operator command, or information scanned from processed mail pieces. Machine state changes may include items such as starting, stopping or delaying of a machine. A mail piece state change may include an indication that a mail piece has entered or exited the machine, or that the mail piece has been manually processed. A metering trip event indicates metering cycling on a single mail piece. An alarm event indicates that the machine has experienced an alarm. A machine cycle event may indicate each chassis cycle and includes information on mail pieces exiting during a cycle. Scanning event entries preferably include each scan from all scan controllers in the machine.

A second kind of entry data 103 are thread context entries. These entries provide contextual information for event entries and are not repeated unless they change. Examples of context entries include device information entries. Device information entries describe a machine module for which information is provided. Within a module, context entries for feeder information and meter identification information may be provided. Thread context entries may also identify accounts that particular processing and postage is charged to. Thread context may include information about any of the systems in the mail production device.

A third, catch-all, type of data entry 103 is a general information entry. A material usage entry reports total material produced or consumed by the devices within the machine. Another exemplary general information entry may include a meter status report, or a meter refill report. General information entries may include a record batches of data submitted to the journal. Finally, a message entry may be included in a journal to record a general purpose message.

Thus, although the invention has been described with respect to a preferred embodiment thereof, it will be understood by those skilled in the art that the foregoing and various other changes, omissions and deviations in the form and detail thereof may be made without departing from the scope of this invention, as further described in the following claims.

What is claimed is:

1. A system for gathering and transmitting detailed inserter machine data to one or more clients, the system comprising:
an inserter controller gathering machine data, the controller programmed to gather predetermined machine data comprising substantially all significant machine data from machine sensors and control routines;
a journal storage system that stores machine data gathered by the inserter controller in a compressed format;
a data pump processing compressed data from the journal and transmitting the processed data in a format suitable for a particular client, the data pump processing including selecting a subset of data from the journal that is of interest to the particular client.

2. The system of claim 1 wherein the journal storage system includes journal files, wherein each journal file stores data for a different mail run.

3. The system of claim 2 wherein the journal storage system stores machine data for a plurality of inserter machines and each data element is associated with a journal thread within the journal files.

4. The system of claim 3 wherein each journal thread is associated with a particular inserter machine.

5. The system of claim 4 wherein the data stored in the journal storage system comprises event entries, thread context entries, and system information entries.

6. The system of claim 1 wherein the data pump determines whether clients are currently active.

7. The system of claim 6 wherein the data pump tracks what data has been transmitted to each client, and whereby if a particular client goes offline, the data pump may resume transmittal at a point where transmittal was interrupted.

8. The system of claim 1 wherein the data pump translates the compressed data from the journal storage system to an XML format.

9. A method for gathering and transmitting detailed inserter machine data to one or more clients, the method comprising:
gathering predetermined machine data comprising substantially all significant machine data from machine sensors and control routines;
storing gathered machine data in a compressed format;
processing compressed data from the journal and transmitting the processed data in a format suitable for a particular client, the processing including selecting a subset of data from the journal that is of interest to the particular client.

10. The method of claim 9 wherein the step of storing includes storing data for different mail runs in different journal files.

11. The method of claim 10 wherein the step of storing further includes storing machine data for a plurality of inserter machines and each data element is associated with a journal thread in the journal files.

12. The method of claim 11 further including associating each journal thread with a particular inserter machine.

13. The method of claim 12 wherein the step of storing includes storing data entries comprising event entries, thread context entries, and system information entries.

14. The method of claim 9 further comprising determining whether clients are currently active.

15. The method of claim 14 further comprising tracking what data has been transmitted to each client, and whereby if a particular client goes offline, resuming transmittal later in time at a point where transmittal was interrupted.

16. The system of claim 9 further comprising translating the stored compressed data to an XML format prior to transmittal to a client.
